(19) United States
(12) Patent Application Publication
(10) Pub. No.: US 2016/0057043 A1
(43) Pub. Date: Feb. 25, 2016

(54) DIAGNOSTIC ROUTING SYSTEM AND METHOD FOR A LINK ACCESS GROUP

(71) Applicant: Level 3 Communications, LLC, Broomfield, CO (US)

(72) Inventor: Eric Osborne, Sutton, MA (US)

(73) Assignee: Level 3 Communications, LLC, Broomfield, CO (US)

(21) Appl. No.: 14/831,497

(22) Filed: Aug. 20, 2015

Related U.S. Application Data
(60) Provisional application No. 62/039,752, filed on Aug. 20, 2014.

(51) Int. Cl. H04L 12/26

(52) U.S. Cl. CPC H04L 43/12; H04L 43/10; H04L 43/0847

(57) ABSTRACT

An apparatus is provided for managing diagnostic routing procedures through a communication node having a link aggregation group (LAG). The apparatus receives a first diagnostic routing request message to perform a diagnostic routing procedure on a communication path between the first communication node and a second communication node. When the communication path between the first communication node and the second communication node is configured in a link aggregation group (LAG), the apparatus transmits a second diagnostic routing request message through each of the links of the LAG to the second communication node, the LAG comprising a plurality of independent links that collectively convey the communication path, and receives a response to the second diagnostic routing request message from the second communication node through one or more of the links.

### CROSS REFERENCE TO RELATED APPLICATIONS

This application claims priority under 35 U.S.C. §119 to U.S. Patent Application No. 62/039,752 titled “Diagnostic Routing System and Method For a Link Aggregation Group,” which was filed on Aug. 20, 2014. The contents of 62/039,752 are hereby incorporated by reference in their entirety.

### TECHNICAL FIELD

The disclosure generally relates to computer networks, and more particularly, to a diagnostic routing system and method for a link access group (LAG).

### BACKGROUND

Networks, such as the Internet, have numerous networking and computing machines that are involved in transmitting data between machines in the network. To improve throughput, link aggregation groups (LAGs) have been developed. Generally speaking, a LAG is a configuration used for packet networks incorporating inverse multiplexing of multiple Ethernet links, thereby increasing bandwidth and providing redundancy. Link aggregation allows one or more links to be bundled or otherwise functionally consolidated such that a media access control (MAC) (e.g., layer 2 of the Open Systems Interconnection (OSI) model) can treat the LAG as if it were a single link. The layer 2 transparency is achieved by the LAG using a single MAC address for all the device's ports in the LAG group. The LAG can be configured as either static or dynamic. Static LAG groups are statically defined and thus may not change over time, whereas dynamic LAG groups may be manipulated while in use using a peer-to-peer protocol for control, such as a link aggregation control protocol (LACP).

### SUMMARY

According to another aspect, an apparatus is provided for managing diagnostic routing procedures through a communication node having a link aggregation group (LAG). The apparatus receives a first diagnostic routing request message to perform a diagnostic routing procedure on a communication path between the first communication node and a second communication node. When the communication path between the first communication node and the second communication node is configured in a link aggregation group (LAG), the apparatus transmits a second diagnostic routing request message through each of the links of the LAG to the second communication node, the LAG comprising a plurality of independent links that collectively convey the communication path, and receives a response to the second diagnostic routing request message from the second communication node through one or more of the links.

### BRIEF DESCRIPTION OF DRAWINGS

The various features and advantages of the disclosure will be apparent from the following description of particular embodiments of the disclosure, as illustrated in the accompanying drawings in which like reference characters refer to the same parts throughout the different views. The drawings are not necessarily to scale and do not necessarily illustrate every functional element of a given arrangement, emphasis instead being placed upon illustrating the principles of the disclosure.

FIG. 1 illustrates an example communication network according to one embodiment of the present disclosure.

FIG. 2 is a block diagram depicting an example routing management application executed on a node in the communication network.

FIG. 3 illustrates an example process that may be performed by the routing management application according to one embodiment of the present disclosure.

FIG. 4 is an example computing system that may implement various systems and methods discussed herein.

### DETAILED DESCRIPTION

Aspects of the present disclosure involve a networking architecture and related apparatus and methods for performing diagnostic routing procedures (e.g., ping, traceroute) on communication paths that traverse one or more link aggregation groups (LAGs). Traditional diagnostic routing procedures have not been designed to discover and exercise specific links of a LAG, which often requires layer 2 routing information (e.g., media access control (MAC) information) about each link. Embodiments of the present disclosure provide a solution to this problem, among other problems, by performing a process in which a diagnostic routing request message is transmitted through each individual link of the LAG such that the performance and/or functionality of each link may be clearly ascertained for providing comprehensive analysis for most or all links that are configured to provide the communication path. In many instances, the presence of a LAG behind a switch may be disguised such that a router or other device sending data through the switch is unaware of the presence of the LAG and hence cannot identify failures or problems in any specific link of the LAG. Aspects of the disclosure may be able to identify such a disguised LAG and test the same, among other advantages.

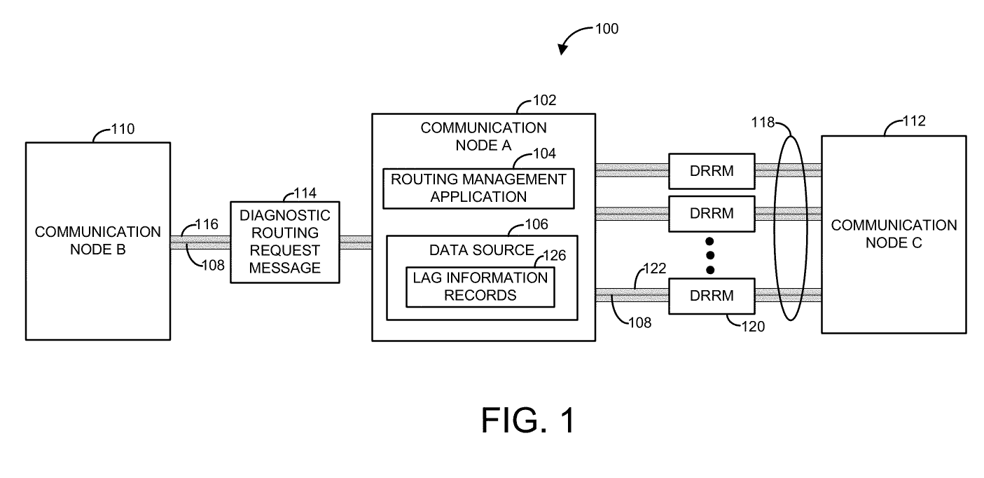

FIG. 1 illustrates an example communication network 100 according to aspects of the present disclosure. The communication network 100 includes a communication node A 102 having a routing management application 104 and a data source 106. The communication node A 102 executes the routing management application 104 for managing a communication path 108 to and from other communication nodes (e.g., communication node B 110 and communication node C 112) in the communication network 100. As will be described in detail below and to illustrate various aspects of the disclosure, the routing management application 104 receives a diagnostic routing request message 114 from the communication node B 110 along the communication path 108 via an upstream link 116, determines whether a downstream link of the communication path 108 includes a LAG communication link 118, and if so, generates individual diagnostic routing request messages (DRRMs) 120 that are transmitted through each individual link 122 of the LAG communication link 118 to test each individual link 122.

The communication network 100 may include any quantity and type of communication nodes (e.g., switches, routers, or other network elements) for providing the communication path 108 from end to end; nevertheless, only three are shown herein for brevity and clarity of discussion. In general, the communication network 100 includes multiple communication nodes (node A 102, node B 110, and node C 112) that communicate among one another using communication links 116 and 122 (e.g., Ethernet). Specifically, node A 102 communicates with node B 110 using a single communication link 116, while node B 110 communicates with node C 112 using a LAG communication link 118, which in this particular example, includes three individual links 122 of the LAG communication link 118. Although the LAG communication link 118 described herein includes three individual communication links 122, it should be understood that the LAG communication link 118 may include any quantity of communication links 122, such as more than three communication links or fewer than three communication links.

In many cases, the operation and identification of the LAG communication link 118 is generally transparent or otherwise hidden to node A 102. That is, the LAG communication link 118 is viewed by node B 110 as a single communication link. Further, in many cases, node B may be a router while Node A is a switch that in effect disguises the presence of the LAG communication link 118. For example, when the LAG communication link 118 is comprised of four 10 Gigabit links, the router (e.g., node B 110) may only understand that there is a 40 Gig link from the switch (Node A 102). Only the nodes (e.g., node A 102 and node C 112), which manage the LAG communication link 118, have specific viewability into the operation of each of the links 122 forming the LAG communication link 118. Although this transparency may be beneficial in some respects, it also possesses drawbacks, such as when most or all communication paths through the LAG communication link 118 needs to be analyzed. For example, diagnostic routing procedures, such as the ping procedure or traceroute procedure have become useful for quickly isolating failures or bottlenecks along communication paths. Nevertheless, because the traditional ping or traceroute procedures have no viewability into the discrete multiple links forming the LAG communication link, failures in any of the discrete links forming the LAG communication link are difficult to assess using these traditional diagnostic routing procedures.

Embodiments of the present disclosure provide a solution to this problem, among other problems, by configuring the node A 102 to, upon receipt of a diagnostic routing request message 114 associated with a particular communication path 108, determine whether any downstream links along that communication path 108 includes a LAG communication link 118, and if so, transmit an individual diagnostic routing request message 120 (e.g., load balance request message) through each individual link 122 of the LAG communication link 118 to the node C 112. The node A 102 may then receive response messages (e.g., load balance response messages) from each individual link 122 and return diagnostic information included in the received response messages to the originating node that issued the diagnostic routing request message 114.

The originating node may be any node along the communication path 108. For example, if the originating node is an upstream node, the subject node transmits the diagnostic information included in the response messages to that upstream node, which in the present case is node B 110. As another example, if the originating node is the subject node such as would be the case if the request were issued through a user interface of the node A 102, then node A 102 may transmit the diagnostic information to the user interface portion of that node.

Each individual diagnostic routing request message 120 may include any type of message that may be used to test or otherwise verify the operating state and/or capability of its respective individual link 122. In one embodiment, each individual diagnostic routing request message 120 includes a load balance request message that queries the far end of the LAG communication link 118 to determine a level of throughput on that individual link 122 relative to the other individual links 122 of the LAG communication link 118. The load balance request messages may be particularly useful for determining whether individual links 122 of a LAG communication link 118 are operational, but operating at a reduced capacity level. Additionally, the load balance request messages may be useful for determining those individual links 122 of the LAG communication link 118 that have failed (e.g., those having essentially little or no throughput level).

The communication network 100 described may form a portion of any suitable type of network, such as, but not limited to, a local area network (LAN), a metropolitan area network (MAN), and a wide area network (WAN). Additionally, the nodes may include any type, such as Internet protocol (IP) routers, frame relay switches, and asynchronous transfer mode switches, and gateways.

According to one embodiment, routing in the described architecture may be performed based on multiprotocol label switching (MPLS), or more specifically MPLS labels, as opposed to using layer 2 or layer 3 headers. Thus, for example, as opposed to analyzing each IPv4 or IPv6 address in a data packet, the present architecture may make forwarding decisions at a higher layer of abstraction where forwarding decisions are made without analyzing the specific IP address or other layer 2 or layer 3 header information, but rather an MPLS label that represents a plurality of IP addresses or other Layer-3 or Layer-2 header information. Such an implementation is particularly useful in a backbone network setting where hardware resources, such as table lookup capacities, are limited.

The data source 106 stores LAG information records 126 that include stored information obtained about the LAG communication link 118. For example, the LAG information records 126 may store information associated with whether the individual links 122 are numbered or unnumbered, the quantity of individual links 122 of the LAG communication link 118, whether the downstream communication node (communication node C 112) is capable of performing the testing techniques described herein. Additionally, the LAG information records 126 may store information associated with a configuration of the LAG communication link 118, such as whether any other node, such as a layer 2 switch, is configured between the node A 102 and node C 112 along the LAG communication link 118.

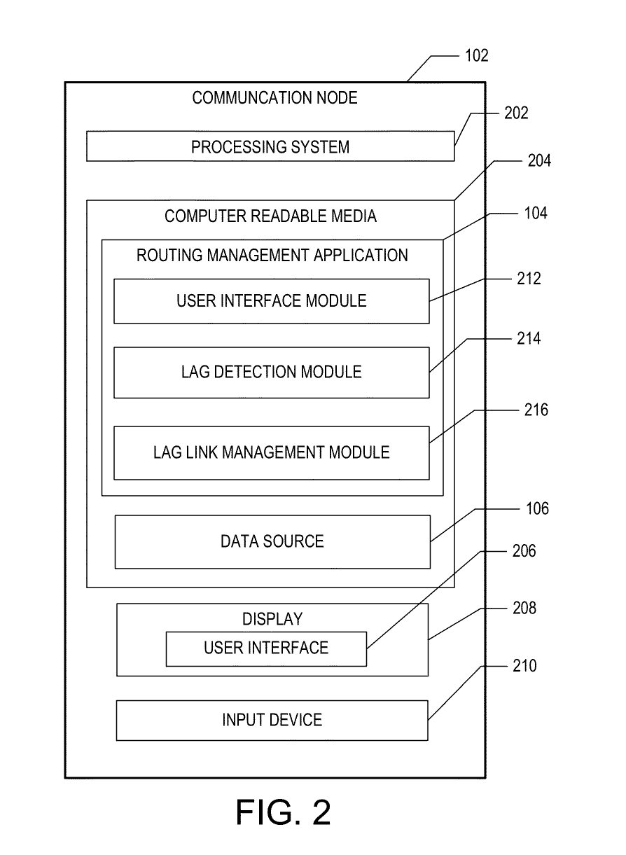

FIG. 2 is a block diagram depicting the routing management application 104 executed on communication node A 102. In other embodiments, the routing management application 104 may be executed on either one, some, or all nodes (e.g., node B 110, node C 112) configured in the communication network 100. According to one aspect, the communication node A 102 includes a processing system 202 having one or more processors or other processing devices. A processor is hardware. Examples of such a communication node may include a router, a switch, or other computing device, such as one or more servers, personal computers, mobile computers and/or other computing devices.

According to one aspect, the communication node A 102 includes a tangible computer readable media 204 on which the routing management application 104 is stored. The computer readable media 204 may include volatile media, nonvolatile media, removable media, non-removable media, and/or another available media that can be accessed by the communication node A 102. The media may be implemented in a method or technology for storage of information, such as computer/machine readable/executable instructions, data structures, program modules, and/or other data. Computer storage media may embody computer readable/executable instructions, data structures, program modules, or other data and include an information delivery media or system, configured to perform the methods discussed herein.

According to one aspect, the communication node A 102 may include a user interface (UI) 206 displayed on a display 208, such as a computer monitor, for displaying data. The communication node A 102 may also include an input device 210, such as a keyboard or a pointing device (e.g., a mouse, trackball, pen, or touch screen) to enter data into or interact with the user interface 206. According to one aspect, the application 104 includes instructions that may be configured in modules that are executable by the processing system 204 as will be described in detail herein below.

A user interface module 212 facilitates the receipt of input data and/or output data from or to a user, respectively. In one example, the user interface module 212 displays a terminal or an emulation of a terminal that may be used for entry of information associated with a diagnostic routing procedure (e.g., a ping procedure, a traceroute procedure, etc.) by a user, and display of the results of the diagnostic routing procedure for view by the user. Additionally, the user interface module 212 may also display one or more selectable fields, editing screens, and the like for receiving the information and commands from the user. Nevertheless, it should be understood that initiation of the diagnostic routing procedure may be generated by another system, process, and/or application executed on any communication node in the network.

A LAG detection module 214 determines whether a communication path 108 through the node is conveyed using a LAG communication link 118 managed by the node. For example, upon receipt of a diagnostic routing request message 114, the LAG detection module 214 may identify the type of link used to convey the communication path 108 along the downstream communication path, and determine whether the link includes a LAG configuration. If so, the LAG detection module 216 may also identify addresses associated with the individual links of the LAG communication link 118, such as any Internet protocol (IP) addresses, and/or media access control (MAC) addresses associated with the communication path. Additionally, the LAG detection module 214 may determine whether numbered or unnumbered addressing is used for addressing each of the individual links 122 of the LAG communication link 118.

In one embodiment, the LAG detection module 214 may communicate with the downstream node associated with the LAG communication link 118 to determine whether that downstream node is capable of performing the diagnostic routing procedure for each individual link 122 of the LAG communication link 118. For example, although the downstream node (e.g., node C 112) may be capable of providing a LAG communication link 118, it may not be configured for testing each link 122 of the LAG communication link 118 using the techniques described herein. Therefore, the LAG detection module 214 may determine whether the downstream node is capable of providing this level of LAG communication link 118 testing prior to performing the test, and performing the diagnostic routing procedure in the traditional manner if the downstream node is not capable.

In another embodiment, the LAG detection module 214 may detect whether the LAG communication link 118 has a configuration that is generally testable, and perform the diagnostic routing procedure in the traditional manner if it is not capable of being tested. For example, if a layer 2 switch has been configured between the subject node (e.g., node A 102) and the downstream node (node C 112), there is no guarantee that traversal of each individual link 122 of the LAG communication link 118 will result in reaching its corresponding interface of the downstream link; a condition that may be typically caused by the layer 2 which often implements its own load balancing mechanism independent of any load balancing configured by the subject node. Therefore, the LAG detection module 214 may detect the presence of any intervening layer 2 switches configured in the LAG communication link 118, and if any are found, perform the diagnostic routing procedure in the traditional manner.

A LAG communication link management module 216 manages diagnostic routing procedure messages received by the node. For example, the LAG communication link management module 216 may continually monitor packets traversing through its respective node for any diagnostic routing procedure messages, and in the event that one is found, process the diagnostic routing procedure message according to any information included in the message. In one embodiment, the LAG communication link management module 216 may be considered to be a snooping device that snoops or otherwise sniffs for certain packets that traverse through its respective node. In a particular example, the LAG communication link management module 216 may upon detection of a diagnostic routing procedure message, communicate with the LAG detection module 214 to identify whether the downstream link comprises a LAG communication link. If so, the LAG communication link management module 216 may communicate with the LAG detection module 214 to ensure that the LAG communication link meets certain criteria, and then accesses the information in the diagnostic procedure routing message and diagnoses the LAG communication link according to the included message.

It should be appreciated that the modules described herein are provided only as an example of a computing device that may execute the routing management application 104 according to the teachings of the present disclosure, and that other computing devices may have the same modules, different modules, additional modules, or fewer modules than those described herein. For example, one or more modules as described in FIG. 2 may be combined into a single module. As another example, certain modules described herein may be encoded and executed on other computing devices, such a computing device that is in communication with a communication node of the communication network 100.

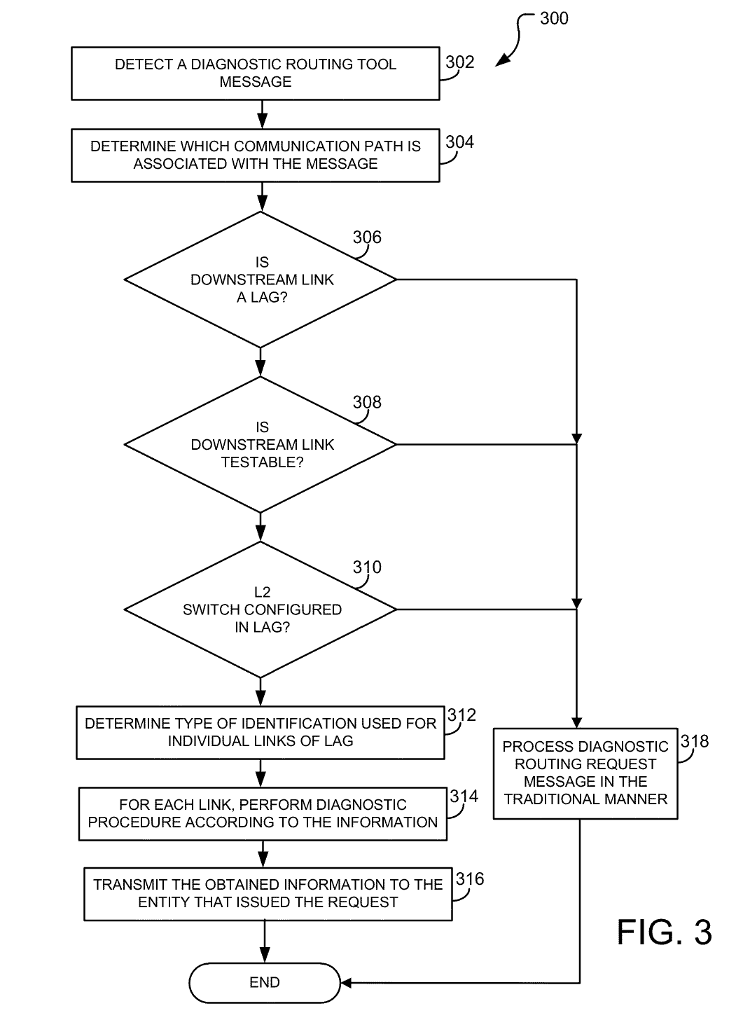

FIG. 3 illustrates an example process that may be performed by the routing management application 104 according to the teachings of the present disclosure. The process described herein may be performed at any time during operation of the communication network 100. For example, the process may be performed while the communication nodes remain in service to diagnose connectivity problems associated with a particular communication path through the communication network 100 in which at least one link between two nodes comprises a LAG communication link 118.

In step 302, the application 104 detects the presence of a diagnostic routing request message 114 received by the node on which the application 104 is executed (e.g., node A 102). In one embodiment, the application 104 comprises a snooping function that continually sniffs packets through the node for the presence of a particular type of packet, which in this particular case, is a diagnostic routing request message that may be, for example, a ping or traceroute diagnostic procedure. The application 104 then determines which communication path 108 that the diagnostic routing request message 114 is associated with in step 304. For example, the application 104 may read the MAC address included in the message to indicate which link of the node is configured as the downstream link for that communication path.

In step 306, the application 104 determines whether the downstream link of the communication path is a LAG communication link 118. If not, processing continues at step 318 in which the diagnostic routing request message is processed in the traditional manner. However, if the application 104 determines that the downstream link includes a LAG communication link 118, processing continues at step 308.

In step 308, the application 104 determines whether the downstream node (e.g., node C 112) is capable of testing individual links 122 of the LAG communication link 118 as described herein. If not, processing continues at step 318 in which the diagnostic routing request message 114 is processed in the traditional manner. However, if the application 104 determines that the downstream node is capable of performing the test, processing continues at step 310. Such behavior of the application 104 may be useful because a downstream node not having the testing capabilities described herein may not respond in any manner to the individual diagnostic routing request messages from any individual link 122 of the LAG communication link 118; a condition that may be difficult to discern between a different condition in which all links have failed.

The application 104 may determine whether the downstream node (e.g., node C 112) is testable in any suitable manner. In one embodiment, the application 104 obtains the information about the downstream node from the LAG information records 126 stored in the data source 106. In other embodiments, the application 104 obtains the information by querying the downstream node, and processing any suitable response messages received from the downstream node (e.g., node C 112).

In step 310, the application 104 determines if a layer 2 switch is configured within any one of the individual links 122. If so, the application 104 performs the diagnostic routing request in the traditional manner at step 318; otherwise, it continues operation at step 312. The application 104 determines if a layer 2 switch exists within at least one of the individual links 122 by techniques, such as obtaining such information from the LAG information records 126, querying a network management tool that manages an overall configuration of the communication network 100, or issuing individual test messages (e.g., ping, traceroute messages) through each link 122 to determine if a layer 2 switch exists along the link 122.

In step 312, the application 104 determines a type of identification used for each individual link 122 of the LAG communication link 118. In general, LAG communication links may be labeled as numbered or unnumbered links. Numbered links refer to an labeling scheme used for LAG communication links in which each individual link 122 is identified by an index (e.g., 1, 2, 3, . . . N), while unnumbered links refer to another labeling scheme in which each individual link 122 is identified by an interface address (e.g., a MAC address of the port of its respective link). As will be described below, the application 104 may use this labeling information for accurately reporting performance information for each individual link using an labeling scheme as provisioned for use by the individual links 122 of the LAG communication link 118.

In step 314, the application 104 performs a diagnostic routing procedure for each link of the LAG communication link 118 according to any diagnostic routing procedure information included in the received diagnostic routing request message 114. The application 104 may perform the diagnostic routing procedure by transmitting an individual diagnostic routing request message 120 through each individual link 122 of the LAG communication link 118, and polling each individual link 122 for a response diagnostic routing request message from the downstream node (e.g., node C 112). The diagnostic routing procedure may include any suitable type of test according to the information included in the received diagnostic routing procedure message. For example, the information may include a request to obtain any load balance information used by the LAG communication link 118 for conveying the communication path 108. As another example, the information may include a request to obtain any individual links of the LAG communication link 118 that may be disconnected or may be experiencing a relatively high bit error rate (BER). As yet another example, the information may include a request to determine whether any of the individual links of the LAG communication link 118 that may be operating at or near its individual throughput capacity.

In step 316, the application 104 transmits the diagnostic information obtained in step 314 to the entity that issued the request to the subject node. For example, the application 104 may forward the obtained information to another node that is upstream along the communication path. As another example, the application 104 may forward the obtained information to the user interface 206 of the node if that is where the request originated from. For example, if node B 110, which is a router, originates the request to node A 102, which is a switch, the application 104 transmits the obtained information to node B 110 which originated the request.

The information may be transmitted to the originating node in any suitable manner. In one embodiment, the information may be formatted according to a downstream detailed mapping type-length-value (TLV) (DDMAP) format. Additionally, the information for each individual link 122 of the LAG communication link 118 may be organized in a DDMAP packet according to a sub-TLV format. For example, information for each individual link 122 of the LAG communication link 118 may be organized in the DDMAP packet as a sub-TLV comprising an identification of each link 122 of the LAG communication link 118 obtained in step 312 along with any diagnostic information obtained from the response message for each individual link 122. In such cases where no response message is received, that individual link 122 may be considered to be in a failed condition and the sub-TLV associated with that individual link 122 generated with a null string or other suitable indicator as the diagnostic information to indicate that the individual link 122 is in a failed state.

The process describes above may be repeated for additional testing of the communication path 108 or other communication paths configured in the communication network 100. Nevertheless, when use of the system is no longer needed or desired, the process ends.

Although FIG. 3 describes one example of a process that may be performed by each node for identifying and processing diagnostic routing tool messages in LAG communication links, the features of disclosed process may be embodied in other specific forms without deviating from the spirit and scope of the present disclosure. For example, the application 104 may perform additional, fewer, or different steps than those steps as described in the present example. As another example, the disclosed steps may be performed on any node along the communication path.

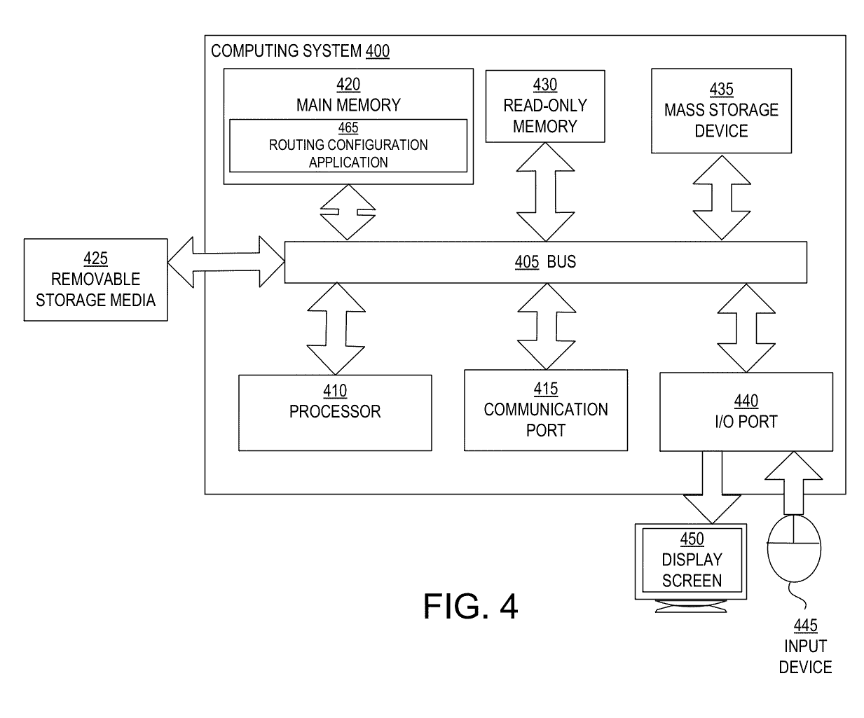

The described systems, methods and apparatus, provide several advantages over conventional systems. For example, the system may provide customizable network services and allow for much more rapid introduction of new services. The system may be more robust as compared to vertically integrated system (particularly at software) which have tended to have more bugs simply resulting from the sheer complexity of conventional vertically integrated systems that are required to include many functions for conforming standards for interoperating autonomously with other devices. For example, FIG. 4 is an example computing system 400 that may implement various systems and methods discussed herein. The computing system may embody a communication node discussed herein.

The computing system 400 includes at least one processor 410, at least one communication port 415, a main memory 420, a removable storage media 425, a read-only memory 430, a mass storage device 435, and an I/O port 440. Processor(s) 410 can be any known processor, such as, but not limited to, an Intel® Itanium® or Itanium 2® processor(s), AMD® Opteron® or Athlon MP® processor(s), or Motorola® lines of processors. The communication port 415 can be any type, such as an RS-232 port for use with a modem based dial-up connection, a 10/100 Ethernet port, a Gigabit port using copper or fiber, or a USB port. Communication port(s) 415 may be chosen depending on a network such as a Local Area Network (LAN), a Wide Area Network (WAN), or any network to which the computer system 400 connects. The computing system 400 may be in communication with peripheral devices (e.g., display screen 450 and a user input device 516) via Input/Output (I/O) port 440.

Main memory 420 can be Random Access Memory (RAM) or any other dynamic storage device(s) commonly known in the art. Read-only memory 430 can be any static storage device(s) such as Programmable Read-Only Memory (PROM) chips for storing static information such as instructions for processor 410. Mass storage device 435 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices, may be used.

The bus 405 communicatively couples processor(s) 410 with the other memory, storage and communications blocks. The bus 405 can be a PCI/PCI-X, SCSI, or Universal Serial Bus (USB) based system bus (or other) depending on the storage devices used. Removable storage media 425 can be any kind of external hard drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), etc.

The computer system 400 includes one or more processors 410. The processor 410 may include one or more internal levels of cache (not shown) and a bus controller or bus interface unit to direct interaction with the processor bus 405. The main memory 420 may include one or more memory cards and a control circuit (not shown), or other forms of removable memory, and may store a routing configuration application 465 including computer executable instructions, that when run on the processor, implement the methods and system set out herein, such as the method discussed with reference to FIGS. 2A and 2B. Other forms of memory, such as a mass storage device 435, a read only memory 430, and a removable storage memory 425, may also be included and accessible, by the processor (or processors) 410 via the bus 405.

The computer system 400 may further include a communication port 415 connected to a transport and/or transit network 455 by way of which the computer system 400 may receive network data useful in executing the methods and system set out herein as well as transmitting information and network configuration changes and MPLS routes or other routes determined thereby. The computer system 400 may include an I/O device 440, or other device, by which information is displayed, such as at display screen 450, or information is input, such as input device 445. The input device 445 may be alphanumeric input device, including alphanumeric and other keys for communicating information and/or command selections to the processor. The input device 445 may be another type of user input device including cursor control, such as a mouse, a trackball, or cursor direction keys for communicating direction information and command selections to the processors 410 and for controlling cursor movement on the display device 450. In the case of a tablet device, the input may be through a touch screen, voice commands, and/or Bluetooth connected keyboard, among other input mechanisms. The system set forth in FIG. 4 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

Additional features of other embodiments are described in Appendix A concurrently filed with the present application.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. An apparatus comprising:
a first communication node comprising at least one processor and at least one memory to store instructions that are executed by the at least one processor to:
receive, by the instructions, a first diagnostic routing request message to perform a diagnostic routing procedure on a communication path between the first communication node and a second communication node;
when the communication path between the first communication node and the second communication node is configured in a link aggregation group (LAG), transmit a second diagnostic routing request message through each of a plurality of individual links of the LAG to the second communication node; and
receive a response to the second diagnostic routing request message from the second communication node through one or more of the individual links.

2. The apparatus of claim 1, wherein the instructions are executed by the at least one processor to:
receive the diagnostic routing request message from a third communication node along the communication path;
forward the response obtained through each of the individual links to the third communication node; and
when at least one of the individual links does not return a successful test request message, identify the at least one individual link as being in a failed state, and include information about the failed state in the forwarded response.

3. The apparatus of claim 2, wherein the response to the diagnostic routing request message is formatted according to a downstream detailed mapping TLV (DDMAP).

4. The apparatus of claim 3, wherein the instructions are executed by the at least one processor to
determine if the links of the LAG comprise a numbered type or an unnumbered type; and
when the links have a numbered type, include an interface address of each link in the DDMAP; and
when the link have an unnumbered type, include an index associated with each link in the DDMAP.

5. The apparatus of claim 1, wherein the instructions are executed by the at least one processor to, prior to transmitting the test request message, transmitting a capability query message to the second communication node, the second communication node responsive to the capability query message to transmit a capability response message indicating whether the second communication node is capable of generating the response to the test request message through the individual links of the LAG.

6. The apparatus of claim 1, wherein the instructions are executed by the at least one processor to:
determine if a data link layer switch is configured between the first communication node and the second communication along the LAG; and
when the data link layer switch exists, cancel transmission for the test request message and transmit information associated with the data link layer switch to an upstream communication node that generated the diagnostic request message.

7. The apparatus of claim 1, wherein the diagnostic routing procedure comprises at least one of a ping procedure and a traceroute procedure.

8. The apparatus of claim 1, wherein the first communication node and the second communication node is configured in a label switched path (LSP) network.

9. The apparatus of claim 1, wherein the test request message comprises a load balance request message.

10. A method comprising:
receiving, using instructions stored in at least one memory and executed by at least one processor, a first diagnostic routing request message to perform a diagnostic routing procedure on a communication path between a first communication node and a second communication node;
when the communication path between the first communication node and the second communication node is configured in a link aggregation group (LAG), transmitting, using the instructions, a second diagnostic routing request message through each of a plurality of individual links of the LAG to the second communication node; and
receiving, using the instructions, a response to the second diagnostic routing request message from the second communication node through one or more of the individual links.

11. The method of claim 10, further comprising:
receiving the diagnostic routing request message from a third communication node along the communication path;
forwarding the response obtained through each of the individual links to the third communication node; and
when at least one of the individual links does not return a successful test request message, identifying the at least one individual link as being in a failed state, and include information about the failed state in the forwarded response.

12. The method of claim 11, further comprising formatting the response to the diagnostic routing request message according to a downstream detailed mapping TLV (DDMAP).

13. The method of claim 12, further comprising:
determining if the individual links of the LAG comprise a numbered type or an unnumbered type; and
when the links have a numbered type, including an interface address of each link in the DDMAP; and
when the link have an unnumbered type, including an index associated with each link in the DDMAP.

14. The method of claim 10, further comprising prior to transmitting the test request message, transmitting a capability query message to the second communication node, the second communication node responsive to the capability query message to transmit a capability response message indicating whether the second communication node is capable of generating the response to the test request message through the individual links of the LAG.

15. The method of claim 10, further comprising:
determining if a data link layer switch is configured between the first communication node and the second communication along the path; and
when the data link layer switch exists, canceling transmission for the test request message and transmit information associated with the data link layer switch to an upstream communication node that generated the diagnostic request message.

16. The method of claim 10, wherein the test request message comprises a load balance request message.

17. A non-transitory computer-readable medium encoded with a route monitoring service comprising instructions executable by a processor to:
receiving a first diagnostic routing request message to perform a diagnostic routing procedure on a communication path between a first communication node and a second communication node;
when the communication path between the first communication node and the second communication node is configured in a link aggregation group (LAG), transmitting a second diagnostic routing request message through each of a plurality of individual links of the LAG to the second communication node; and
receiving a response to the second diagnostic routing request message from the second communication node through one or more of the links.

18. The instructions of claim 17, further operable to perform:
receiving the diagnostic routing request message from a third communication node along the communication path;
forwarding the response obtained through each of the individual links to the third communication node; and
when at least one of the links does not return a successful test request message, identifying the at least one link as a failed link and include information about the failed link in the forwarded response.

19. The instructions of claim 17, further operable to perform prior to transmitting the test request message, transmitting a capability query message to the second communication node, the second communication node responsive to the capability query message to transmit a capability response message indicating whether the second communication node is capable of generating the response to the test request message through the links of the LAG.

20. The instructions of claim 17, further operable to perform:
determining if a data link layer switch is configured between the first communication node and the second communication along the path; and
when the data link layer switch exists, canceling transmission for the test request message and transmit information associated with the data link layer switch to an upstream communication node that generated the diagnostic request message.
